(19) United States
(12) Patent Application Publication
(10) Pub. No.: US 2018/0091793 A1
(43) Pub. Date: Mar. 29, 2018

(54) IMAGE PROCESSING APPARATUS, IMAGING APPARATUS, IMAGE PROCESSING METHOD, AND STORAGE MEDIUM

(71) Applicant: CANON KABUSHIKI KAISHA, Tokyo (JP)

(72) Inventor: Shigeo Ogawa, Yokohama-shi (JP)

(21) Appl. No.: 15/708,446

(22) Filed: Sep. 19, 2017

(30) Foreign Application Priority Data
Sep. 23, 2016 (JP) 2016-185617

(51) Int. Cl. H04N 13/00; H04N 5/235

(52) U.S. Cl. CPC H04N 13/0022; H04N 5/2353; H04N 13/0037

(57) ABSTRACT

An image processing apparatus includes a range acquiring unit configured to acquire a refocusable range in the refocus process, which is a distance range in which a refocus is available, an exposure acquiring unit configured to acquire a plurality of first exposure values in accordance with luminance values of a plurality of distances in the refocusable range, an exposure setting unit configured to set a second exposure value as an exposure value in the imaging, a correction value acquiring unit configured to acquire a luminance correction value based on a refocus distance as a distance to be refocused in the refocus process and at least one first exposure value and at least one second exposure value, and a processing unit configured to provide the refocus process with the luminance correction value.

### BACKGROUND OF THE INVENTION

### Field of the Invention

The present invention relates to an imaging apparatus configured to provide imaging used for refocus and a refocus process.

### Description of the Related Art

The known refocus technology combines a plurality of parallax images (or viewpoint images) each having a parallax obtained by imaging or image capturing from a plurality of imaging positions (viewpoints) and generates a refocused image as an image in which an in-focus state is adjusted after imaging. Japanese Patent Laid-Open No. 2011-022796 discloses a refocus process that generates a refocused image by shifting and combining a plurality of parallax images in accordance with the viewpoints of the plurality of parallax images and the object distance to be focused so that the same main object is superimposed on itself.

The conventional imaging determines an exposure value and a dynamic range for a main object to be focused, which is determined before the imaging. An image having a corrected luminance can be generated through image processing to an image acquired through imaging. However, it is difficult to correct the luminance of an image that contains the overexposure and underexposure, and color curving of a high chroma part, and increased noises, etc. can occur. For example, when an exposure value is adjusted to a main object in an imaging scene having a large brightness or luminance difference, another object may suffer from the overexposure or underexposure. At this time, even when the luminance is corrected through image processing to another overexposed object, in particular, a proper exposure may not be obtained.

Assume that a user attempts to generate an image targeted on an object different from the main object through a post-imaging refocus process. Then, the object can be focused but the proper luminance may not be obtained depending on the exposure condition in the imaging.

### SUMMARY OF THE INVENTION

The present invention provides an imaging apparatus etc., which can provide a refocused image in which each object has proper luminance even when a main object is changed in a refocus process in capturing an imaging scene having a large luminance difference.

An image processing apparatus according to one aspect of the present invention is configured to generate a refocused image through a refocus process with a plurality of parallax images each having a parallax acquired through imaging. The image processing apparatus includes one or more processors, and a memory storing instructions which, when executed by the one or more processors, causes the one or more processors to perform operations of units of the image processing apparatus. The units include a range acquiring unit configured to acquire a refocusable range in the refocus process, which is a distance range in which a refocus is available, an exposure acquiring unit configured to acquire a plurality of first exposure values in accordance with luminance values of a plurality of distances in the refocusable range, an exposure setting unit configured to set a second exposure value as an exposure value in the imaging, a correction value acquiring unit configured to acquire a luminance correction value based on a refocus distance as a distance to be refocused in the refocus process and at least one first exposure value and at least one second exposure value, and a processing unit configured to provide the refocus process with the luminance correction value.

Further features of the present invention will become apparent from the following description of exemplary embodiments with reference to the attached drawings.

### BRIEF DESCRIPTION OF THE DRAWINGS

FIG. 1 is a block diagram of a configuration of an imaging apparatus according to this embodiment of the present invention.

FIG. 2 illustrates a configuration of an optical system of an imaging unit in the imaging apparatus according to this embodiment.

FIG. 3 illustrates part of an image sensor in the imaging apparatus according to this embodiment.

FIG. 4 illustrates parallax image data and a refocused image obtained by combining the parallax image data according to this embodiment.

FIG. 5 illustrates a difference between an object and the imaging apparatus according to this embodiment.

FIG. 6 illustrates a luminance difference caused by an arrangement of objects according to this embodiment.

FIG. 7 is a flowchart of an exposure determination process according to this embodiment.

FIG. 8 is a flowchart of a post-imaging luminance correcting refocus process according to this embodiment.

### DESCRIPTION OF THE EMBODIMENTS

Referring now to the accompanying drawings, a description will be given of embodiments of the present invention.

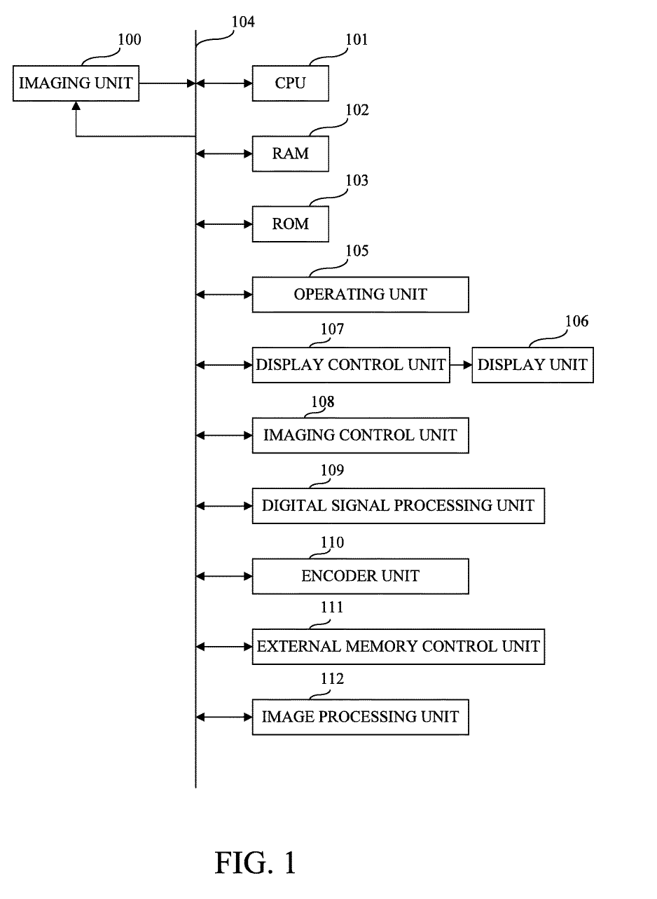

FIG. 1 illustrates a configuration of an imaging apparatus according to one embodiment of the present invention. An imaging unit 100 photoelectrically converts (captures), through an image sensor, which will be described later, light (object image) from the object and obtains image data by A/D-converting the electric signal (analog signal) output from the image sensor. The imaging unit 100 obtains image data in response to an imaging command input from a user via an operating unit 105, etc., and stores the obtained image data into an unillustrated recording medium. The image data obtained by the imaging unit 100 is displayed as a so-called live-view image on a display unit 106 provided to the imaging apparatus.

The imaging unit 100 in this embodiment captures images of the same imaging scene from a plurality of viewpoints (imaging positions) in accordance with one imaging command, and obtains a plurality of pieces of image data each having a parallax (which will be referred to as “a plurality of parallax images” hereinafter).

A central processing unit (referred to as a “CPU” hereinafter) 101 is a processor configured to generally control each component in the imaging apparatus. A RAM 102 is a memory that serves as a main memory, a work area, etc. for the CPU 101. A ROM 103 is a memory that stores a control program etc. executed by the CPU 101. A bus 104 is a transmission channel for various types of data and, for example, the image data obtained by the imaging unit 100 is transmitted to a predetermined processing unit via this bus 104. The operating unit 105 is an input device configured to input a command provided from the user into the CPU 101, and includes an operating member, such as a button, a mode dial, a touch screen having a touch input function, etc.

The display unit 106 includes a liquid crystal display, etc., and displays an image, a letter, etc. The display unit 106 may include a touch screen included in the operating unit 105. A display control unit 107 controls displaying an image, a letter, etc., on the display unit 106.

An imaging control unit 108 controls focusing, opening and closing of a shutter, an aperture diameter adjustment of an aperture stop in the imaging unit 100, etc. based on a command from the CPU 101. A digital signal processing unit 109 performs various image processing, such as a white balance process, a gamma process, a noise reduction process, etc. for image data received via the bus 104 (which contains a refocused image, which will be described later), and generates digitally processed image data.

An encoder unit 110 converts the digitally processed image data received via the bus 104 into a file format, such as a JPEG and an MPEG. An external memory control unit 111 is an interface that connects the imaging apparatus to a personal computer and another medium, such as a hard disk drive, an optical disc drive, and a semiconductor memory. The image data obtained or generated by the imaging apparatus is output to an external storage unit via the external memory control unit 111 and stored.

An image processing unit 112 performs a refocus process, which will be described later, using a plurality of parallax images obtained by the imaging unit 100, generates a refocused image, and performs image processing that generates an output image using digitally processed image data output from the digital signal processing unit 109. The CPU 101 and the image processing unit 112 constitute an image processing apparatus.

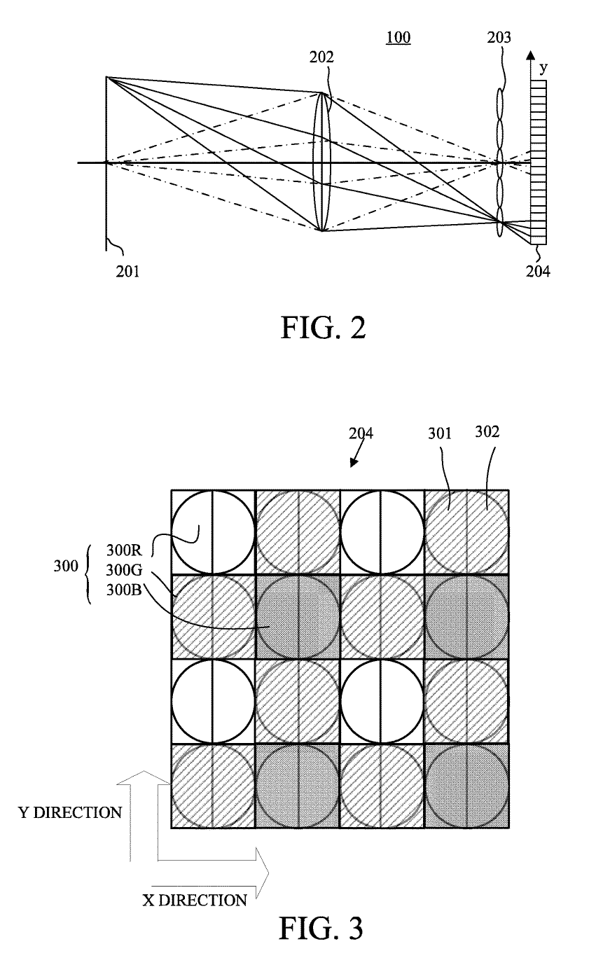

Referring now to FIG. 2, a description will be given of a configuration of an optical system in the imaging unit 100. The optical system in the imaging unit 100 includes a main lens 202, a lens array 203, and an image sensor 204. FIG. 2 simplifies the configuration of the optical system, but may include the aperture stop, a color filter, etc. and the main lens may include a plurality of lenses. The lens array 203 includes a two-dimensional array of fine convex lens cells, and is approximately conjugate with an object plane 201 with respect to the main lens 202 on the image side. The image sensor 204 is disposed approximately conjugate with an exit pupil in the main lens 202 with respect to the lens array 203. The thus-configured imaging unit 100 is also referred to as a plenoptic camera, and an image containing information (light field) relating to the light incident direction can be obtained.

FIG. 3 illustrates part of the image sensor 204. A pixel unit 300 includes two pixels in an x direction and two pixels in a y direction, or a pixel 300R having a spectral sensitivity of R (red) at an upper left position, pixels 300G having a spectral sensitivity of G (green) at upper right and lower left positions, and a pixel 300B having a spectral sensitivity of B (blue) at a lower right position. Each pixel includes a first subpixel 301 and a second subpixel 302 that are divided into two in the x direction.

As illustrated in FIG. 2, a plurality of rays from the object plane 201 pass the main lens 202 and the lens array 203, and enter a plurality of different pixels on the image sensor 204 according to the exit positions and the exit angles on the object plane 201 of the rays. A plurality of rays that are emitted from one point on the object plane 201 and enter the main lens 202 image at one point on the lens array 203 irrespective of their exit directions. The plurality of rays imaged at the one point on the lens array 203 exit in different directions according to the incident angles on the lens array 203, and enter different pixels on the image sensor 204 (such as the first subpixel 301 and the second subpixel 302 in FIG. 3, for example). In other words, the light fluxes having different exit angles from the object or the light fluxes observed when the object is viewed from different directions are distinguished from one another and recorded on the image sensor 204. Hence, a plurality of parallax images obtained through imaging by the plenoptic camera contains information on the object viewed from a plurality of different viewpoints. A plurality of parallax images corresponding to a plurality of different viewpoints can be obtained by extracting and arranging pixels corresponding to the light fluxes that have passed the same region in the main lens 202.

FIG. 3 illustrates pixels that are divided into two in the x direction for simplicity, but the pixels may be divided into two both in the x direction and in the y direction. While this embodiment obtains a plurality of parallax images each having a parallax through the plenoptic camera, the plurality of parallax images may be obtained by a so-called multi-eye camera in which a plurality of cameras are two-dimensionally arranged.

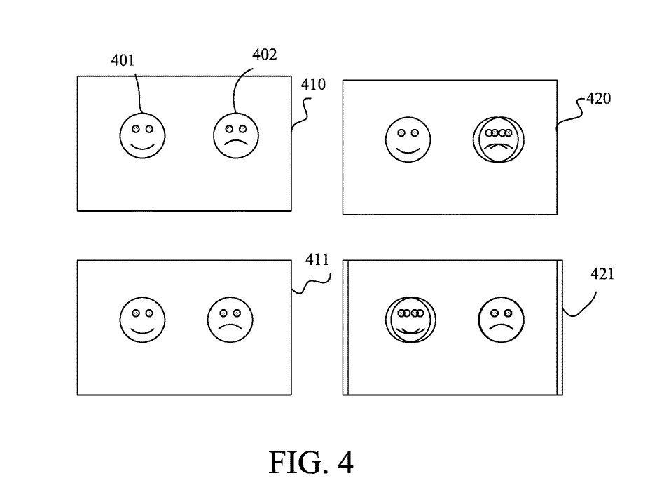

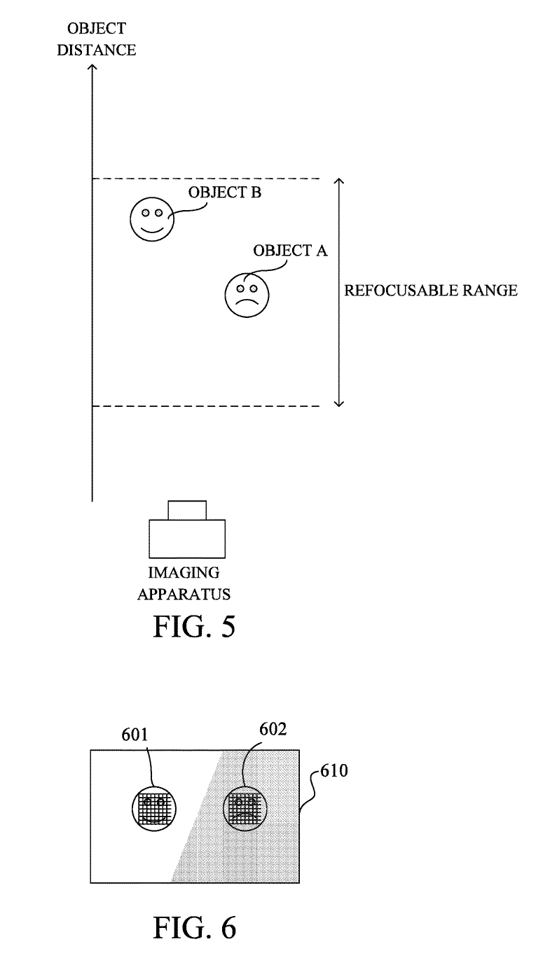

Referring now to FIGS. 4 and 5, a refocus process will be described. FIG. 4 illustrates two parallax images 410 and 411 corresponding to two horizontally arranged viewpoints or left and right viewpoints and refocused images 420 and 421 obtained by combining these parallax images 410 and 411. FIG. 5 illustrates positions of objects A and B relative to the imaging apparatus. Each of the parallax images 410 and 411 contains two object images 401 and 402. As illustrated in FIG. 5, the object A corresponding to the object image 402 is closer than the object B corresponding to the object image 401.

The object images 401 and 402 have parallaxes depending on the object distances of the objects A and B. The refocused images 420 and 421 obtained by combining the parallax images 410 and 411 have different shift amounts of the parallax images 410 and 411 in combining the parallax images 410 and 411. The refocused image 420 is an image obtained by shifting and combining the parallax images 410 and 411 so as to superimpose the object image 401 on itself, and the object image 401 (the object A as a main object) is focused. On the other hand, in the parallax images 410 and 411, the object image 402 has a parallax different from that of the object image 401 in magnitude, and thus is combined at a shifted position in the refocused image 420. Hence, the object image 402 is blurred in the refocused image 420.

The refocused image 421 is an image obtained by shifting and combining the parallax images 410 and 411 so as to superimpose the object image 402 on itself, and the object image 402 is focused (the object B as the main object). On the other hand, in the parallax images 410 and 411, the object image 401 has a parallax different from that of the object image 402 in magnitude, and thus is combined at a shifted position in the refocused image 421. Hence, the object image 401 blurs in the refocused image 421.

A predetermined object distance (in-focus distance) is focused by shifting and combining a plurality of parallax images by a shift amount determined based on the object to be focused, and a refocused image that has a blur depending on a distance difference from the in-focus distance can be generated.

As illustrated in FIG. 5, both of the object A and the object B having an object distance longer than (farther than) the object A are located in the refocusable range. The refocusable range is a range of an object distance that can generate a refocused image focused on an object based on a plurality of parallax images obtained through imaging. The refocusable range can be calculated by a known method based on parallax information obtained by the image sensor 204 explained in FIG. 3 and information on the object distance of the object A located at the center of the refocusable range.

A description will now be given of an illustrative imaging scene having a large luminance difference to be solved by this embodiment. FIG. 6 illustrates an imaging scene that contains an object 601 located in a bright area and an object 602 located in a dark area. The object 602 is closer than the object 601, and serves as a main object to be focused, for which an exposure value is to be determined. The proper exposure can be calculated for the object 602 by diving a rectangular area inscribed in the face area in the object 602 into a plural meshes and by calculating a luminance value of each divided area. Setting the exposure value in imaging so that the exposure value can be proper for the object 602 in the dark area causes the overexposure because the object 601 located in the bright area is more brightly imaged, and the area of the object 601 may become the overexposure (luminance or brightness saturation) area. It is difficult to correct the luminance of this luminance saturation area through image processing so that it has the proper exposure.

Accordingly, in imaging the imaging scene having a large luminance difference, this embodiment determines the exposure value in imaging and corrects the luminance through image processing after imaging so that each main object can have proper exposure even when the main object is varied in the refocus process.

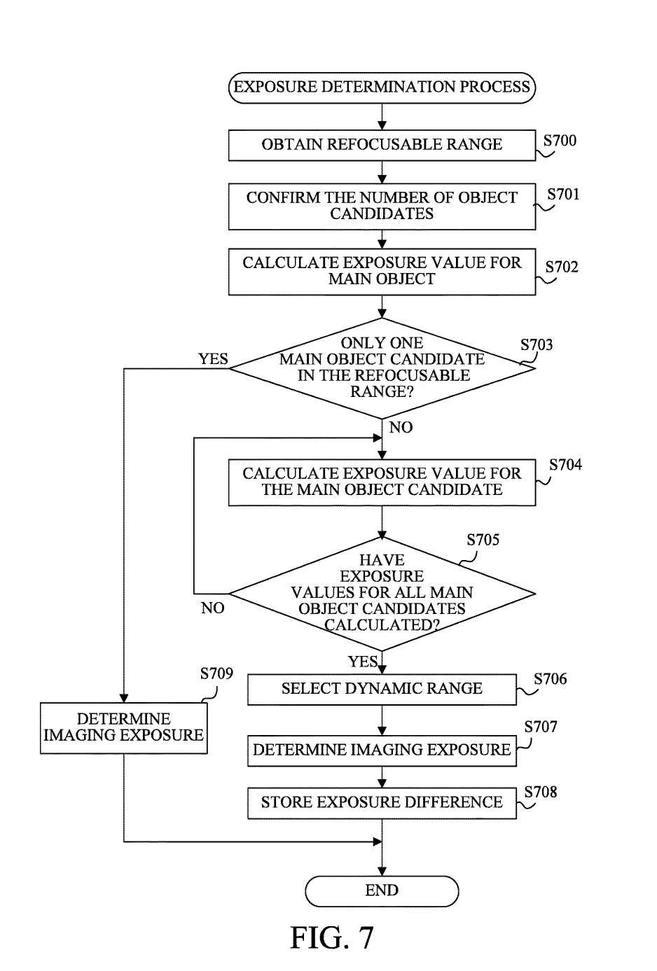

A flowchart in FIG. 7 illustrates an exposure determination process (image processing method) according to this embodiment for determining the exposure value in imaging an imaging scene having a large luminance difference. The CPU 101 executes this process in accordance with an image processing (imaging control) program as a computer program. The CPU 101 serves as a range acquiring unit, an object detecting unit, an exposure acquiring unit, an exposure setting unit, and an exposure difference storing unit. In the following description, “S” stands for the step.

In S700, the CPU 101 calculates (obtains) a refocusable range through the above-mentioned method. Next, in S701, the CPU 101 detects a candidate of a main object (main object candidate) in the refocusable range based on image data acquired in an imaging preparation before main imaging for acquiring a plurality of parallax images (image data for live-view images). Then, the CPU 101 confirms the number of main object candidates. In the example illustrated in FIG. 5, there are two main object candidates (objects A and B) in the refocusable range. The main object candidates are detected based on a known process, such as a face recognition process and an object detection process. When a plurality of main object candidates are detected, the CPU 101 determines one main object based on the detection reliability, the detected distance, size, or another element of the object candidate, etc.

Next, in S702, the CPU 101 obtains an exposure value for obtaining a proper exposure for the main object determined in S701 (a first exposure value at an object distance with which the main object is located). When the object is a human, as described with reference to FIG. 6, the rectangular area inscribed in the face area of the main object is divided into meshes, the luminance value is calculated for each divided area, and the luminance value of the face area is calculated by applying a predetermined weight. Then, the exposure value (exposure time period, F-number, and ISO speed) that provides a proper luminance level to the luminance of the face area using the calculated luminance value is determined as a main object exposure value. Even when the main object is not a human, the exposure value that provides a proper luminance level to an area that contains the main object is similarly determined as a main object exposure value.

In S703, the CPU 101 determines whether or not only one main object candidate has been confirmed by S701. When there is only one main object candidate, the main object does not change in the refocus process and thus the CPU 101 moves to S709, where the CPU 101 determines the exposure value calculated in S702 as the exposure in imaging (referred to as “an imaging exposure” hereinafter). On the other hand, when there are two or more main object candidates, the CPU 101 moves to S704.

In S704, the CPU 101 calculates a luminance value for a main object candidate different from the main object determined in S701. The luminance value is calculated similarly to a calculation of the luminance value of the main object described in S702. The CPU 101 uses the calculated luminance value, and calculates the exposure value (first exposure value with the object distance with which the other main object candidate is located) as the candidate exposure value, which enables the other main object candidate to have the proper luminance level.

In S705, the CPU 101 determines whether or not a calculation of the candidate exposure value has been completed for all main object candidates in the refocusable range, and the flow returns to S704 when the calculation has not yet been completed so as to calculate the luminance values for the remaining main object candidates. Then, the CPU 101 determines the candidate exposure values. When the calculation has been completed, the flow moves to S706.

In S706, the CPU 101 calculates a maximum exposure difference that is a difference between a maximum overexposure value and a minimum underexposure value among the main object exposure value and the candidate exposure values calculated in the previous steps. When the maximum exposure difference is larger than a predetermined value, such as 1 Ev, the CPU 101 determines that the dynamic range is to be extended (set). Expending the dynamic range is a process of expanding the dynamic range by applying a gamma curve that captures an image with an exposure value set to the underexposure by 1 EV and increases the intermediate luminance by 1 Ev in the post-imaging image process.

Next, in S707, the CPU 101 sets an imaging exposure value (second exposure value) as an exposure value in imaging for obtaining a plurality of parallax images. More specifically, the CPU 101 selects, as the imaging exposure value, the maximum overexposure value (the maximum exposure value) among the main object exposure value and candidate exposure values calculated hitherto.

Next, in S708, the CPU 101 calculates an exposure difference as a difference between the imaging exposure value and the main object exposure value set in S707 and an exposure difference as a difference between the imaging exposure value and each candidate exposure value. Moreover, the CPU 101 correlates the calculated exposure difference with each of the main object and the main object candidate, and stores (or records) the calculated exposure difference in the internal memory. For example, the calculated exposure difference may be recorded as accessory information of the image file. Then, the CPU 101 ends this process.

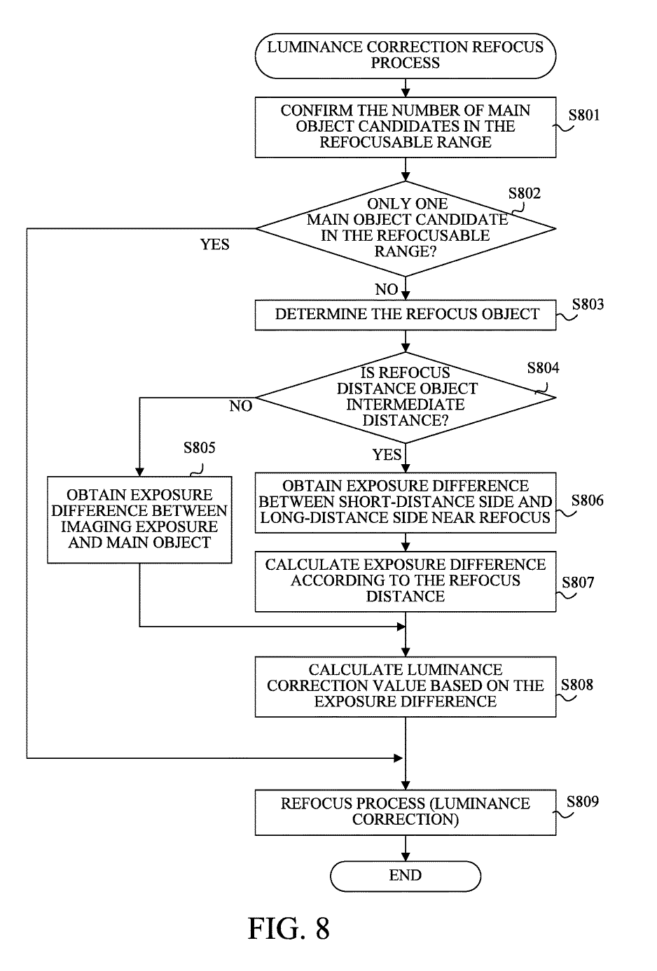

Referring now to FIG. 8, a description will be given of the luminance correction refocus process (image processing method) for generating a refocused image and for providing a luminance correction process. The CPU 101 executes this process in accordance with the image processing program. The CPU 101 serves as a correction value acquiring unit in this process, and the image processing unit 112 serves as a processing unit.

In S801, the CPU 101 confirms the number of object candidates in the refocusable range similar to S701 in FIG. 7.

In S802, the CPU 101 determines only one main object candidate has been confirmed in S801, similar to S703 in FIG. 7. When there is only one main object candidate, the luminance correction is unnecessary since the image has been captured with the proper exposure for the sole main object. Thus, the CPU 101 moves to S810 so as to perform a refocus process for generating a refocused image in which the sole main object is refocused, and then ends this process. On the other hand, where there are two or more main object candidates, the CPU 101 moves to S803.

Next, in S803, the CPU 101 determines a refocus object as a main object to be focused or refocused in the refocus process among the plurality of main object candidates. In other words, the CPU 101 determines the refocus distance as an object distance to be refocused.

Next, in S804, the CPU 101 determines whether the final refocus distance is a CPU refocus distance as the refocus distance determined in S803 or a user refocus distance adjusted from the refocus distance by the user. The CPU 101 moves to S805 when the final refocus distance is the CPU refocus distance. Where the final refocus distance is the user refocus distance and the user refocus distance is closer than the closest object candidate or farther than the farthest object candidate, the flow moves to S805. On the other hand, where the final refocus distance is a distance between a certain object candidate and another object candidate (referred to as an “object intermediate distance” hereinafter), the CPU 101 moves to S806.

In S805, the CPU 101 reads an exposure difference corresponding to the refocus object (or CPU refocus distance) among the exposure differences stored in S708 illustrated in FIG. 7, and sets it to the refocus exposure difference. Then, the flow moves to S808.

On the other hand, in S806, the CPU 101 reads out two exposure differences corresponding to the main object candidates located at the object distances before and after the refocus distance (object intermediate distance) among the exposure differences stored in S708 illustrated in FIG. 7. For example, where the refocus distance is the object intermediate distance between the object A and the object B illustrated in FIG. 5, the CPU 101 reads out the exposure differences correlated with the objects A and B. Where the refocus distance is closer than the object A, the CPU 101 reads only one exposure difference correlated with the object A. In addition, where the refocus distance is farther than the object B, the CPU 101 reads out only one exposure difference correlated with the object B.

In S807, the CPU 101 determines the refocus exposure difference in accordance with the refocus distance based on the two exposure differences read out in S806. More specifically, the CPU 101 selects one main object distance with a closer distance than the refocus distance, selects the exposure difference corresponding to the main object candidate among the two exposure differences, and determines the selected exposure difference as the refocus exposure difference. Alternatively, the CPU 101 may calculate the refocus exposure difference based on an interpolation calculation with the distance using the two exposure differences. Where the refocus distance is closer to the object A, the CPU 101 sets the exposure difference corresponding to the object A and read out in S806 to the refocus exposure difference. Where the refocus distance is farther to the object B, the CPU 101 sets the exposure difference corresponding to the object B and read out in S806 to the refocus exposure difference. Thus, the CPU 101 sets the refocus exposure difference in accordance with the refocus distance in S805 to S807. Then, the flow moves to S808.

In S808, the CPU 101 converts the refocus exposure difference set in accordance with the refocus distance in S805 and S807, into the luminance correction value. The refocus exposure value is expressed as a power of 2 or (2ⁿ) where n corresponds to the luminance correction value. The luminance correction value is a gain value for the luminance correction.

In S809, the CPU 101 makes the image processing unit 112 perform the refocus process using the luminance correction value determined in S808. In this refocus process, the image processing unit 112 provides the luminance correction process for the plurality of pre-combination parallax images obtained by imaging or the refocused image generated by combining the parallax images. Thereby, a well refocused image can be generated which contains a main object (image) having a proper luminance.

The processes described in FIGS. 7 and 8 can provide the main object in the refocused image with the proper luminance even when a main object to be focused is varied in the refocus process using the plurality of parallax images obtained by capturing the imaging scene having a large luminance difference.

In this embodiment, the CPU 101 stores the exposure difference as the difference between the imaging exposure value and the main object and candidate exposure values, obtains the refocus exposure difference corresponding to the refocus distance using the exposure difference, and acquires the luminance correction value based on the refocus exposure value. Alternatively, the CPU 101 may store the imaging exposure value, the main object exposure value, the candidate exposure value, obtain the refocus exposure value corresponding to the refocus distance based on these exposure values, acquire the refocus exposure difference as the difference between the imaging exposure value and the refocus exposure value, and finally procure the luminance correction value. In other words, storing and using the exposure difference are equivalent with storing and using the imaging exposure value, the main object exposure value, and the candidate exposure value.

While this embodiment describes the imaging apparatus that includes the imaging unit and the imaging processing apparatus, the image processing apparatus may be configured separate from the imaging apparatus having the imaging unit. In this case, a plurality of parallax images acquired by the imaging apparatus (imaging unit) may be input into the image processing apparatus using the communication and the recording medium.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-185617, filed on Sep. 23, 2016, which is hereby incorporated by reference herein in its entirety.

What is claimed is:

1. An image processing apparatus configured to generate a refocused image through a refocus process with a plurality of parallax images each having a parallax acquired through imaging, the image processing apparatus comprising:
one or more processors; and
a memory storing instructions which, when executed by the one or more processors, causes the one or more processors to perform operations of units of the image processing apparatus,
wherein the units include:
a range acquiring unit configured to acquire a refocusable range in the refocus process, which is a distance range in which a refocus is available,
an exposure acquiring unit configured to acquire a plurality of first exposure values in accordance with luminance values of a plurality of distances in the refocusable range;
an exposure setting unit configured to set a second exposure value as an exposure value in the imaging;
a correction value acquiring unit configured to acquire a luminance correction value based on a refocus distance as a distance to be refocused in the refocus process and at least one first exposure value and at least one second exposure value; and
a processing unit configured to provide the refocus process with the luminance correction value.

2. The image processing apparatus according to claim 1, wherein the units further include an object detecting unit configured to detect an object contained in the refocusable range, and
wherein the exposure acquiring unit acquires the first exposure value for each distance of each of the plurality of objects detected in the refocusable range.

3. The image processing apparatus according to claim 1, wherein the correction value acquiring unit acquires the luminance correction value based on a difference between the first exposure value corresponding to the refocus distance or the exposure value corresponding to the refocus distance obtained based on the at least one first exposure value and the second exposure value.

4. The image processing apparatus according to claim 1, wherein the exposure setting unit sets the second exposure value based on a maximum exposure value among the plurality of the first exposure values.

5. The image processing apparatus according to claim 1, wherein the units further include a storing unit configured to store an exposure difference correlated with the distance, which is a difference between the first and second exposure values corresponding to the plurality of distances.

6. The image processing apparatus according to claim 1, wherein the exposure setting unit sets a dynamic range according to a maximum difference in the first exposure values corresponding to the plurality of distances.

7. An imaging apparatus comprising:
an imaging unit configured to acquire a plurality of parallax images each having a parallax through imaging; and
an image processing apparatus configured to generate a refocused image through a refocus process with the parallax images,
wherein the image processing apparatus includes:
one or more processors; and
a memory storing instructions which, when executed by the one or more processors, causes the one or more processors to perform operations of units of the image processing apparatus,
wherein the units include:
a range acquiring unit configured to acquire a refocusable range in the refocus process, which is a distance range in which a refocus is available,
an exposure acquiring unit configured to acquire a plurality of first exposure values in accordance with luminance values of a plurality of distances in the refocusable range;
an exposure setting unit configured to set a second exposure value as an exposure value in the imaging;
a correction value acquiring unit configured to acquire a luminance correction value based on a refocus distance as a distance to be refocused in the refocus process and at least one first exposure value and at least one second exposure value; and
a processing unit configured to provide the refocus process with the luminance correction value.

8. An image processing method configured to generate a refocused image through a refocus process with a plurality of parallax images each having a parallax acquired through imaging and executed by one or more processors in accordance with instructions stored in a memory which, when executed by the one or more processors, causes the one or more processors to perform the steps of:
acquiring a refocusable range in the refocus process, which is a distance range in which a refocus is available,
acquiring a plurality of first exposure values in accordance with luminance values of a plurality of distances in the refocusable range;
setting a second exposure value as an exposure value in the imaging;
acquiring a luminance correction value based on a refocus distance as a distance to be refocused in the refocus process and at least one first exposure value and at least one second exposure value; and
providing the refocus process with the luminance correction value.

9. A non-transitory computer-readable storing medium storing an image processing program that enables a computer to execute an image processing method configured to generate a refocused image through a refocus process and a plurality of parallax images each having a parallax acquired through imaging and executed by one or more processors in accordance with instructions stored in a memory which, when executed by the one or more processors, causes the one or more processors to perform the steps of:
acquiring a refocusable range in the refocus process, which is a distance range in which a refocus is available,
acquiring a plurality of first exposure values in accordance with luminance values of a plurality of distances in the refocusable range;
setting a second exposure value as an exposure value in the imaging;
acquiring a luminance correction value based on a refocus distance as a distance to be refocused in the refocus process and at least one first exposure value and at least one second exposure value; and
providing the refocus process with the luminance correction value.
